(19) United States
(12) Patent Application Publication
(10) Pub. No.: US 2024/0304793 A1
(43) Pub. Date: Sep. 12, 2024

(54) ELECTRODES AND BATTERIES COMPRISING THE SAME

(71) Applicant: GM GLOBAL TECHNOLOGY OPERATIONS LLC, Detroit, MI (US)

(72) Inventors: James Joseph Deininger, Wyandotte, MI (US); Raffaello Ardanese, Bloomfield Hills, MI (US)

(73) Assignee: GM GLOBAL TECHNOLOGY OPERATIONS LLC, Detroit, MI (US)

(21) Appl. No.: 18/179,455

(22) Filed: Mar. 7, 2023

(51) Int. Cl. H01M 4/36; B23K 26/57; B41M 5/382; H01M 4/04; H01M 4/583

(52) U.S. Cl. CPC H01M 4/366; B23K 26/57; B41M 5/382; H01M 4/0404; H01M 4/583; B23K 2101/36; H01M 2004/021

(57) ABSTRACT

Electrodes and batteries comprising such electrodes are provided. The electrodes include a current collector, and a coating on the current collector. The coating includes more than one layer that includes an active material. The coating also includes a first surface facing away from the current collector that has a maximum height (Sz) surface roughness of greater than 60 micrometers (μm), a maximum peak height (Sp) surface roughness of greater than 40 micrometers (μm), and an arithmetical mean height (Sa) surface roughness greater than 10 micrometers (μm).

### INTRODUCTION

The technical field generally relates to battery manufacturing, and more particularly relates to electrodes and batteries comprising the electrodes that have significant surface roughness.

Various methods are used to produce battery components, such as anodes and cathodes. While many of these processes have been successful, there are ongoing efforts to producing new component architectures and improving overall quality.

Accordingly, it is desirable to provide processes for battery component manufacturing that allow for alternative component architectures. In addition, it is desirable to provide processes that allow for improved component quality. Furthermore, other desirable features and characteristics of the present invention will become apparent from the subsequent detailed description and the appended claims, taken in conjunction with the accompanying drawings and the foregoing technical field and background.

### SUMMARY

An electrode is provided for a battery. In one embodiment, the electrode includes a current collector, and a coating on the current collector. The coating includes more than one layer that includes an active material. The coating includes a first surface facing away from the current collector that has a maximum height (Sz) surface roughness of greater than 60 micrometers (μm), a maximum peak height (Sp) surface roughness of greater than 40 micrometers (μm), and an arithmetical mean height (Sa) surface roughness greater than 10 micrometers (μm).

In various embodiments, the surface roughness of the first surface may be 10 to 180 micrometers (μm).

In various embodiments, the active material may include graphite.

In various embodiments, the electrode may have a minimum specific capacity of charge of 168 to 178 milliampere-hours per gram mass (mAh/g) for a first 40 cycles.

In various embodiments, the electrode may have a minimum columbic efficiency of 99%.

In various embodiments, the coating may include a plurality of overlapping material pixels that define the more than one layer thereof.

In various embodiments, the coating may include edges that include protrusions extending from the first surface and a central region therebetween.

In various embodiments, the coating may include a protrusion extending from the first surface to an extent of at least 80 micrometers (μm) above portions of the first surface adjacent thereto. The presence of the protrusion does not negatively affect the electrochemical performance of the electrode.

A battery is provided. In one embodiment, the battery includes an electrode having a current collector, and a coating on the current collector. The coating may include more than one layer that includes an active material. The coating may include a first surface facing away from the current collector that has a maximum height (Sz) surface roughness of greater than 60 micrometers (μm), a maximum peak height (Sp) surface roughness of greater than 40 micrometers (μm), and an arithmetical mean height (Sa) surface roughness greater than 10 micrometers (μm).

In various embodiments, the surface roughness of the first surface may be 10 to 180 micrometers (μm).

In various embodiments, the active material may include graphite.

In various embodiments, the electrode may have a minimum specific capacity of charge of 168 to 178 milliampere-hours per gram mass (mAh/g) for a first 40 cycles.

In various embodiments, the electrode has a minimum columbic efficiency of 99%.

In various embodiments, the coating may include a plurality of overlapping material pixels that define the more than one layer thereof.

In various embodiments, the coating may include edges that include protrusions extending from the first surface and a central region therebetween.

In various embodiments, the coating includes a protrusion extending from the first surface to an extent of at least 80 micrometers (μm) above portions of the first surface adjacent thereto. The presence of the protrusion does not negatively affect the electrochemical performance of the battery.

A method is provided for producing a component of a battery. In one embodiment, the method includes forming a donor layer of a donor material on a donor substrate, locating the donor layer adjacent to and spaced apart from a receiving substrate, generating a laser beam having a wavelength, wherein the donor substrate is substantially transparent at the wavelength of the laser beam, directing, with a processor of a controller, the laser beam toward the donor substrate such that the laser beam passes through the donor substrate and is focused on an interface between the donor substrate and the donor layer, irradiating the donor layer with the laser beam to cause portions of the donor layer to eject and contact the receiving substrate to form material pixels thereon, forming a solid body comprising more than one layer of the material pixels, and producing the electrode wherein the coating of the electrode includes at least a portion of the solid body and the current collector of the electrode includes at least a portion of the receiving substrate.

In various embodiments, the solid body may be one of a plurality of spaced apart solid bodies on the receiving substrate.

In various embodiments, the method may include segmenting the solid body into more than one portion, wherein the coating of the electrode includes one of the more than one portions of the solid body.

In various embodiments, the method may include installing the electrode in the battery.

### BRIEF DESCRIPTION OF THE DRAWINGS

The exemplary embodiments will hereinafter be described in conjunction with the following drawing figures, wherein like numerals denote like elements, and wherein:

FIG. 1 is a side view schematically represented a system for producing various components of batteries in accordance with an embodiment;

FIG. 2 is a top view of a product produced by the system of FIG. 1 in accordance with an embodiment;

FIG. 3 is a top view of batteries comprising components produced with the system of FIG. 1 in accordance with an embodiment;

FIG. 4 is a flow chart illustrating a method for producing various components of batteries in accordance with an embodiment;

FIGS. 5 and 6 are cross-sectional and side views, respectively, of an exemplary product produced with the system of FIG. 1 in accordance with an embodiment;

FIG. 7 is a graph comparing surface roughness to a slope of discharge capacity observed during experimental investigations leading to certain aspects of an embodiment.

FIG. 8 is a graph depicting coulombic efficiency parameters observed during experimental investigations leading to certain aspects of an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

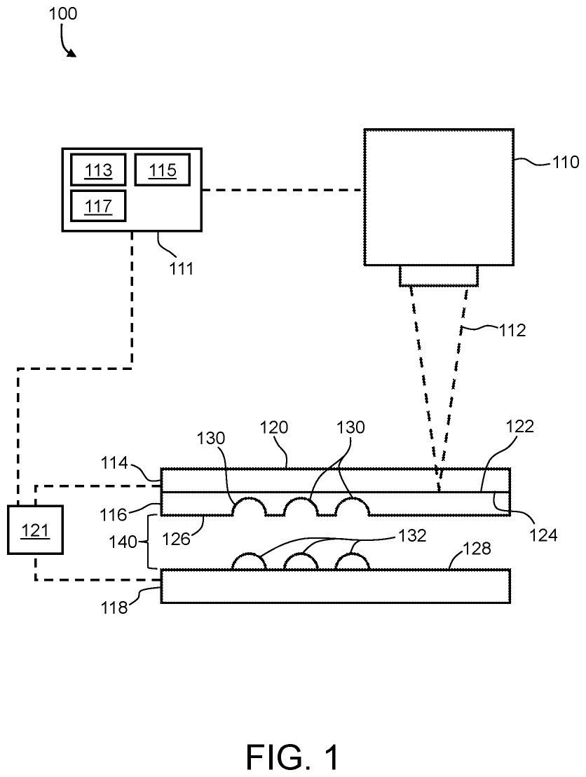

FIG. 1 presents an exemplary system 100 for producing battery components, such as anodes and cathodes. The system 100 utilizes a laser-induced forward transfer (LIFT) printing technique for deposition of component materials. The system 100 includes a laser generating source 110 configured to produce a laser beam 112, a donor substrate 114, a donor layer 116 coated or otherwise applied to surfaces of the donor substrate 114, and a receiving substrate 118 spaced apart from the surfaces of the donor substrate 114 having the donor layer 116 applied thereto. For convenience, the system 100 will be described relative to the orientation represented in FIG. 1; however, the system 100 is not necessarily limited to such orientation. As such, the donor substrate 114 is referred to herein as having an upper or top surface 120 facing the laser generating source 110 and a lower or bottom surface 122 facing the receiving substrate 118 and having the donor layer 116 applied thereto, the donor layer 116 is referred to herein as having an upper or top surface 124 in contact with lower surface 122 of the donor substrate 114 and a lower or bottom surface 126 facing opposite the upper surface 124 thereof, and the receiving substrate 118 is referred to as having an upper or top surface 128 facing the lower surface 126 of the donor layer 116 thereon.

In general, the system 100 may be operated to selectively deposit material of the donor layer 116, referred to herein as donor material, onto the upper surface 128 of the receiving substrate 118. More specifically, the laser generating source 110 may generate and direct the laser beam 112 toward the upper surface 120 of the donor substrate 114. The laser beam 112 may be modified, directed, and/or focused on an interface between the donor substrate 114 and the donor layer 116, for example, by optical elements such as mirrors, beam splitters, and/or lenses. Operation of the system 100 including, for example, controlling the laser generating source 110, any other components for modifying, directing, and/or focusing the laser beam 112 (e.g., scanners with galvanometric mirrors, lens, etc.), and any components for moving the donor substrate 114 and/or the receiving substrate 118 (e.g., motion stages) may be controlled by a controller 111.

The controller 111 includes at least one processor 113, a communication bus 115, and a computer readable storage device or media 117. The processor 113 performs the computation and control functions of the controller 111. The processor 113 can be any custom made or commercially available processor, a central processing unit (CPU), a graphics processing unit (GPU), an auxiliary processor among several processors associated with the controller 111, a semiconductor-based microprocessor (in the form of a microchip or chip set), a macroprocessor, any combination thereof, or generally any device for executing instructions. The computer readable storage device or media 117 may include volatile and nonvolatile storage in read-only memory (ROM), random-access memory (RAM), and keep-alive memory (KAM), for example. KAM is a persistent or nonvolatile memory that may be used to store various operating variables while the processor 113 is powered down. The computer-readable storage device or media 117 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 111 in controlling the system 100. The bus 115 serves to transmit programs, data, status and other information or signals between the various components of the system 100. The bus 115 can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor 113, receive and process signals, perform logic, calculations, methods and/or algorithms, and generate data based on the logic, calculations, methods, and/or algorithms. Although only one controller 111 is shown in FIG. 1, embodiments of the system 100 can include any number of controllers 111 that communicate over any suitable communication medium or a combination of communication mediums and that cooperate to process the sensor signals, perform logic, calculations, methods, and/or algorithms, and generate data.

As can be appreciated, that the controller 111 may otherwise differ from the embodiment depicted in FIG. 1. For example, the controller 111 may be coupled to or may otherwise utilize one or more remote computer systems and/or other control systems, for example as part of one or more of the above-identified devices and systems. It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 113) to perform and execute the program. Such a program product may take a variety of forms, and the present disclosure applies equally regardless of the particular type of computer-readable signal bearing media used to carry out the distribution. Examples of signal bearing media include recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 111 may also otherwise differ from the embodiment depicted in FIG. 1, for example in that the computer system of the controller 111 may be coupled to or may otherwise utilize one or more remote computer systems and/or other control systems.

The wavelength of the laser beam 112 may, and preferably does, substantially match or is similar to the transparency of the donor substrate 114 and an absorption ability of the donor layer 116. With such arrangement, the laser beam 112 may pass through the donor substrate 114 and irradiate the donor layer 116 thereon.

Portions 130 of the donor layer 116 irradiated by the laser beam 112 may be ejected from the donor layer 116 and controllably deposited on the receiving substrate 118. As used herein the individual deposited materials are referred to as material pixels 132. Patterns of the material pixels 132 may be formed by scanning and/or rastering the laser beam 112 (e.g., by scanners with galvanometric mirrors) and/or by moving the donor substrate 114 and/or the receiving substrate 118 (e.g., with a motion stage 121). In various embodiments, the laser beam 112 may be scanned over the donor layer 116 at a rate of between 20 and 50 meters per second (m/s).

In various embodiments, the lower surface 122 of the donor substrate 114 and/or the lower surface 126 of the donor layer 116 thereon are oriented substantially parrel to the upper surface 128 of the receiving substrate 118 prior to operation of the laser generating source 110. A gap or spacing 140 between the donor layer 116 and the receiving substrate 118 may be between, for example, a few tenths of a micron to a few millimeters, depending on the composition of the donor material. For example, non-Newtonian inks may require a narrower space 140 whereas Newtonian inks may allow for a wider space 140. In some embodiments, the laser beam 112 is directed to be substantially perpendicular to the lower surface 122 of the donor substrate 114. In other embodiments, the laser beam 112 is directed toward the donor substrate 114 at an angle that is not perpendicular to the lower surface 122 of the donor substrate 114.

In various embodiments, the laser generating source 110 may be configured to pulse the laser beam 112, for example, having a laser repetition rate (i.e., pulses) of several nanoseconds, picoseconds, or femtoseconds. In some embodiments, the laser generating source 110 is configured to produce a continuous wave laser beam 112. The laser beam 112 may be generated at various wavelengths. The laser beam 112 may be generated to have a power of about a few milliwatts to several hundred watts.

The system 100 may be configured to controllably deposit the donor material by controlling various parameters of the system 100. In some embodiments, the system 100 is configured to deposit the material pixels 132 to overlap, having a dots-per-inch of about 5% to about 90%.

The donor substrate 114 is primarily provided to mechanically support the donor layer 116 and therefore may be configured to be at least moderately rigid relative to the donor material. As the donor substrate 114 is also preferably substantially transparent to the laser beam 112, suitable materials for the donor substrate 114 may include various glass materials (e.g., for near-infrared and visible wavelengths), quartz or fused silica (e.g., for ultra-violet wavelengths), or various polymeric materials such as polyethylene terephthalate (PET). The donor substrate 114 may have various cross-sectional thicknesses, such as about 5 to 1,000 micrometers (μm).

The donor layer 116 may be applied to the donor substrate 114 with various techniques. In some embodiments, a thin layer of ink including the donor material may be uniformly applied on the lower surface 122 of the donor substrate 114. Exemplary techniques for application of the ink may include, but are not limited to, spin-coating, blade-coating, or with a continuous ink feeding system, such as a roll-to-roll (R2R) coating system.

To cause ejection of the portions 130 of the donor layer 116 irradiated by the laser beam 112, the ink may include at least one component that is configured to absorb radiation at the wavelength of the laser beam 112. Alternatively, or in addition, non-linear absorption may be promoted by using femtosecond laser beam pulses. In various embodiments, a thin intermediate (sacrificial) layer may be located between the donor substrate 114 and the donor layer 116 that is configured to absorb radiation at the wavelength of the laser beam 112. The intermediate layer may be, for example, a thin film (e.g., tens to hundreds of nanometers) of various metallic and polymeric materials that are configured to decompose during deposition to minimize contamination on the receiving substrate 118. In some embodiments, the ink may include an active material, a solvent, and optionally one or more additional materials such as a binder. In such embodiments, the ink may include between about 5 to 20 weight percent (wt. %) active material and 5 to 75 wt. % solvent. Nonlimiting examples of active materials include, but are not limited to, graphite, and carbon black. The donor layer 116 may have various cross-sectional thicknesses, such as about 5 to 1,000 micrometers (μm).

The receiving substrate 118 may include one or more materials including but not limited to various metallic materials. In some embodiments, the receiving substrate 118 may include materials similar to those used to produce battery components with various other techniques, such as roll-to-roll (R2R) coating. Nonlimiting examples of the receiving substrate 118 include, but are not limited to, copper or an alloy thereof, aluminum or an alloy thereof, and certain polymer substrates. The receiving substrate 118 may have various cross-sectional thicknesses, such as about 5 to 1,000 micrometers (μm).

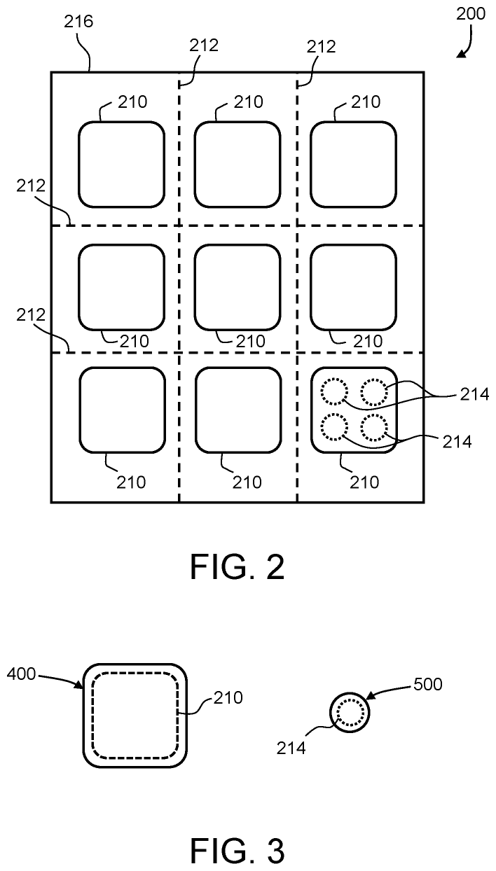

The system 100 may be configured to produce various patterns of the material pixels 132 on the receiving substrate 118. In some embodiments, the system 100 is configured to produce one or more solid bodies 210 on the receiving substrate 118. As used herein, the term solid body refers to a body formed by material pixels 132 that overlap such that no spaces or gaps are located therebetween. Such solid bodies 210 may have various shapes, sizes, thicknesses, porosity, and roughness. FIG. 2 presents a nonlimiting example of a receiving substrate 118 having a plurality of rectangular solid bodies 210 of deposited donor material. Notably, the solid bodies 210 may have various other shapes and sizes than those presented in FIG. 2. In some embodiments, the receiving substrate 118 may be an elongated sheet and the bodies may be formed thereon with the system 100 in a continuous manner.

The solid bodies 210 may include one or more layers of one or more materials from corresponding donor layers 116. In various embodiments, the solid bodies 210 may include multiple layers of a single donor material. In other embodiments, the solid bodies 210 may include multiple layers of more than one donor material. For example, the solid bodies 210 may include a first layer of a first donor material, a second layer of a second donor material, and a third layer of a third donor material.

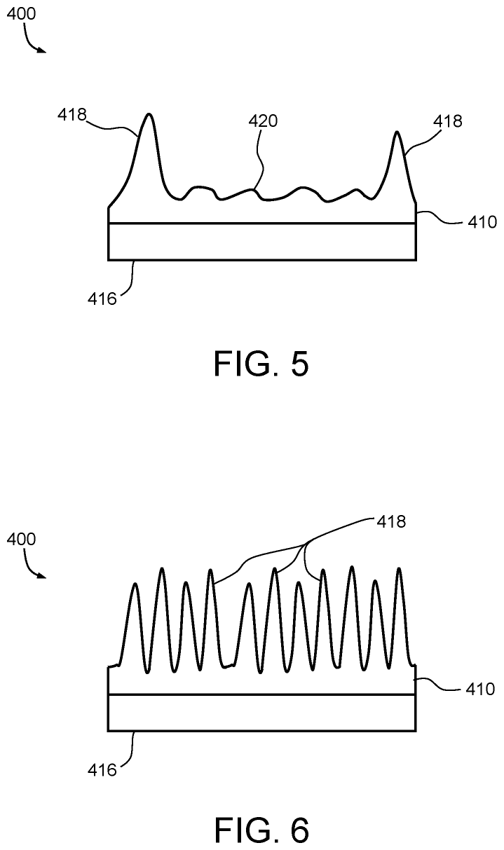

In various embodiments, the material pixels 132 be deposited to control a resulting surface roughness of the solid bodies 210, and/or an architecture of the solid bodies 210. For example, the thickness of the solid bodies 210 may be intentionally modified over the surface thereof to produce a predetermined architecture. In various embodiments, the solid bodies 210 may include at least one protrusion extending from the surface thereof to an extent of at least 10 micrometers (μm) above portions of the surface adjacent thereto, such as about 10 to 180 μm, such as at least about 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, or 170 μm. In some embodiments, the presence of the protrusion(s) do not negatively affect the electrochemical performance of the component of the battery produced from the solid body 210. As a nonlimiting example, FIG. 5 presents a cross-sectional view of a solid body 410 formed on a receiving substrate 416. In this example, the solid body 410 includes outer edges having protrusions 418 extending from a first surface thereof with a central region 420 therebetween. FIG. 6 presents a side view showing a plurality of the protrusions 418 extending along the outer edges. This fence-like architecture may be produced by depositing more layers of material pixels 132 along the outer edges than within the central region 420. In various embodiments, architectures such as these may be produced that have little to no effect on the performance of the resulting battery component.

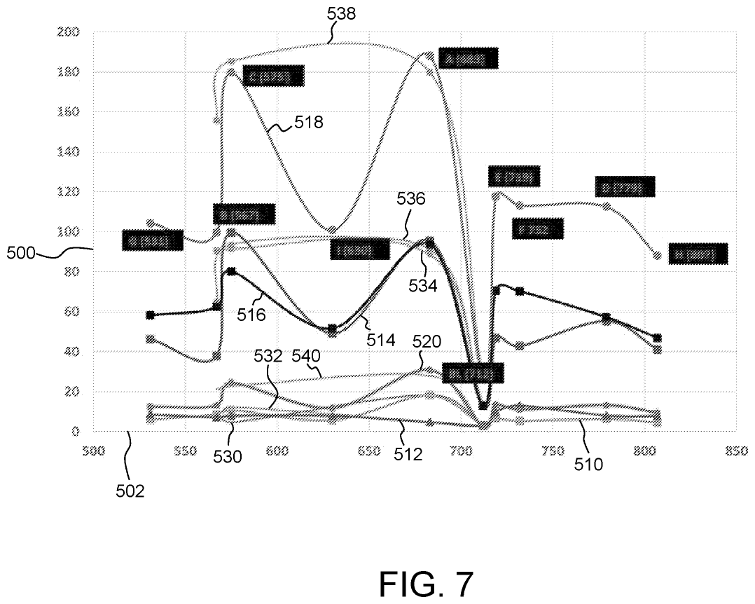

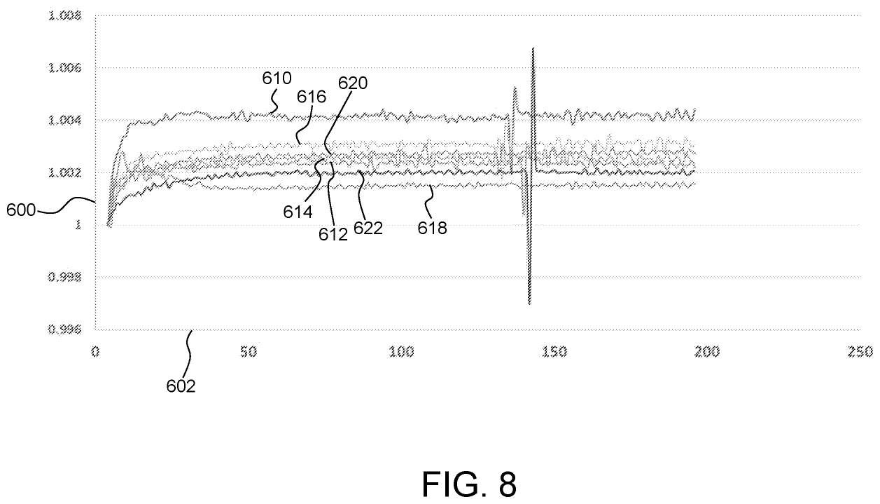

In various embodiments, the surface roughness of the solid bodies 210 may be significantly different than products formed of similar materials with other processes such as roll-to-roll (R2R) coating. For example, experimental investigations leading to certain aspects of the present invention were performed in which six separate surface roughness parameters (i.e., root mean square height (Sq), Kurtosis (Sku), maximum peak height (Sp), maximum pit height (Sv), maximum height (Sz), and arithmetical mean height (Sa)) were measured for samples formed by a LIFT process described herein and with a roll-to-roll (R2R) coating process. The investigations determined that the measured parameters of the LIFT-produced samples differed from 42 to 270 percent relative to the R2R-produced samples. FIG. 7 is a graph depicting exemplary surface roughness measurements (y-axis; labeled 500; micrometers) relative to slope of discharge capacity (x-axis; labeled 502). The data include anode squares with Sq labeled 510 (squares), Sku labeled 512 (triangles), Sp labeled 514 (squares), Sv labeled 516 (squares), Sz labeled 518 (circles), and Sa labeled 520 (smaller circles), and coin cells with Sq labeled 530 (X's), Sku labeled 532 (thin line), Sp labeled 534 (circles), Sv labeled 536 (squares), Sz labeled 538 (squares), and Sa labeled 540 (thick line). FIG. 8 is a graph depicting exemplary coulombic efficiency parameters as determined at the various points identified in FIG. 7 including point A labeled 610, point B labeled 612, point C labeled 614, point E labeled 616, point F labeled 618, point G labeled 620, and point I labeled 622. These results indicated that the LIFT process described herein is capable of producing products having significantly different surface roughness properties relative to various other techniques. In various embodiments, the solid bodies 210 may have a surface roughness of about 10 to 180 μm. In various embodiments, the solid bodies 210 may have an Maximum height (Sz) surface roughness of greater than 60 micrometers (μm), an Maximum peak height (Sp) surface roughness of greater than 40 μm, and an Arithmetical mean height (Sa) surface roughness greater than 10 μm.

The solid bodies 210 may be formed as final products for installation as components in batteries (e.g., a battery 400 of FIG. 3), or may be segmented into one or more partial bodies 214 for installation as components in batteries (e.g., a battery 500 of FIG. 3). In some embodiments, the solid bodies 210 or partial bodies 214 may undergo various post-processing or finishing processes prior to installation as components in batteries. In one nonlimiting example, each of the solid bodies 210 may be segmented (e.g., by a mechanical punching process) into separate partial bodies 214 and installed as components of coin cell batteries. Optionally, the receiving substrate 118 may be segmented to separate the solid bodies 210, for example, along lines 212.

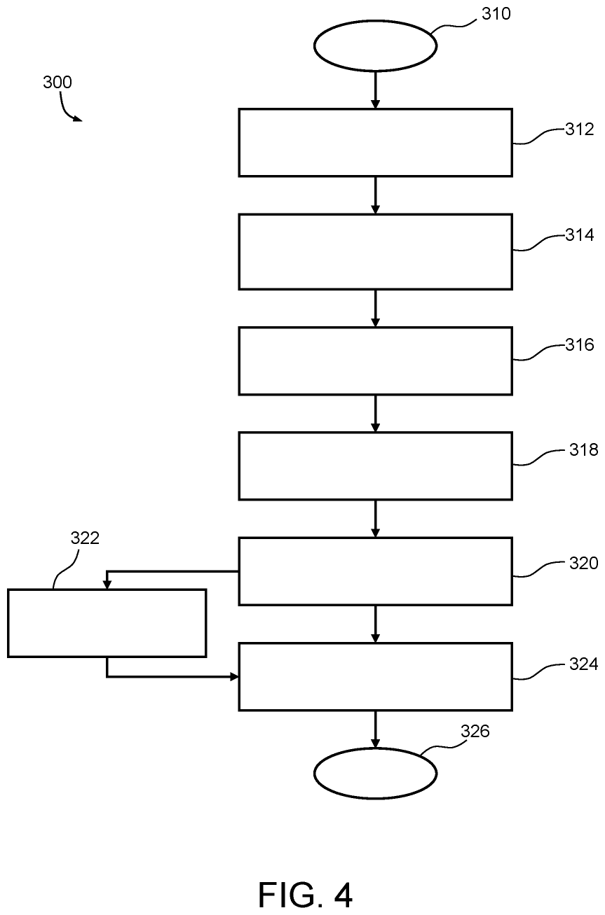

With reference now to FIG. 4 and with continued reference to FIGS. 1-2, a flowchart provides a method 300 for producing components for batteries as performed by the system 100, in accordance with exemplary embodiments. As can be appreciated in light of the disclosure, the order of operation within the method 300 is not limited to the sequential execution as illustrated in FIG. 4, but may be performed in one or more varying orders as applicable and in accordance with the present disclosure. One or more of the steps of the method 300 may be performed by a processor of a controller, such as the processor 113 of the controller 111.

In one example, the method 300 may start at 310. At 312, the method 300 may include applying a donor material to a first (e.g., lower) surface 122 of the donor substrate 114 and curing the donor material to form the donor layer 116 on the first surface 122 of the donor substrate 114. At 314, the method 300 may include locating the donor substrate 114 such that the donor layer 116 is substantially parallel to a (e.g., upper) surface 128 of a receiving substrate 118 with a space provided therebetween. At 316, the method 300 may include, by the processor 113, generating the laser beam 112, directing the laser beam 112 toward a second (e.g., upper) surface 120 of the donor substrate 114 opposite the first surface 122 thereof, and focusing the laser beam 112 at an interface of the donor substrate 114 and the donor layer 116, wherein the donor substrate 114 is substantially transparent to a wavelength of the laser beam 112 and the donor material includes at least one component configured to absorb the wavelength of the laser beam 112. At 318, the method 300 may include controlling, by the processor 113, the laser beam 112 to irradiate the donor layer 116 to selectively eject portions 130 of the donor layer 116 therefrom such that the portions 130 are deposited on the donor substrate 114 as the material pixels 132. At 320, the method 300 may include depositing a plurality of the material pixels 132 to form a solid body 210 on the receiving substrate 118. At 322, the method 300 may optionally include segmenting the solid body 210 into one or more partial bodies 214. At 324, the method 300 may include installing the solid body 210 and/or the partial body 214 as a component in a battery. The method 300 may end at 326.

The system 100 and the method 300 may be used to produce various components for batteries, such an anodes and cathodes. For embodiments wherein the component produced is an electrode, such electrode may include a current collector having a coating of an active material thereon, wherein the current collector is defined by at least a portion of the receiving substrate 118 and the coating of the active material is defined by at least a portion of the solid body 210.

In a nonlimiting example, an electrode for a battery was produced in accordance with aspects disclosed herein. The electrode included a composition, formed from the solid body 210, that included about 20 to 40 wt. % graphite as an active material, about 1 to 8 wt. % poly(vinylidene fluoride) (PVDF) as a binder, about 1 to 8% carbon, and N-methyl-2-pyrrolidone (NMP) 20 to 80%. The current collector, formed from the receiving substrate 118, included a layer of copper having a thickness of about 10 micrometers (μm). The electrode had an areal capacity of about 2.4 milliampere-hours per square centimeter (mAh/cm²), an active material loading of about 6.5 milligrams per square centimeter (mg/cm²), and a thickness of about 60 m (excluding the current collector).

The exemplary electrode described above was produced by depositing a diluted anode solution (Nanomyte BE-200E) on a donor substrate to form a donor layer. A LIFT system was then utilized to deposit material pixels ejected from the donor layer onto a receiving substrate. The resulting solid body was segmented to define the electrode and subsequently installed in a coin cell for testing.

The system 100 and the method 300 may provide various benefits over prior art processes for producing battery components. As examples, the system 100 is capable of producing components for batteries having various surface features, architectures, shapes, and materials. The system 100 has few material limitations, is capable of deposition at high speeds (relative to other processes), provides excellent quality control (e.g., a low coefficient of variance), and produces little waste. Various parameters (e.g., material density, material pixel distance, cure time, laser power, etc.) of the system 100 may be adjusted for battery cell optimization including battery properties such as capacity, charge rate, and range.

The surface roughness and architecture of the battery components may be significantly varied with little to no reduction in electrochemical performance relative to components formed by other processes of similar materials. In some embodiments, the components produced by the system 100 and/or the method 300 provide electrochemical performance that exceeds that of components formed by other processes of similar materials.

The systems and methods disclosed herein, including the system 100 and the method 300, provide a capability to produce battery components, such as electrodes, with a low coefficient of variance. This may provide for component standardization for benchmarking, comparison, validation, and battery development. The batteries produced by the system and methods disclosed herein may be used in various applications including, but not limited to, various vehicles such as certain electric vehicles, hybrid vehicles, etc., various portable consumer electronics, various grid-scale energy storage, various military equipment, and various aerospace applications.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An electrode for a battery, the electrode comprising:
a current collector; and
a coating on the current collector, the coating including more than one layer of at least one active material and having a first surface facing away from the current collector, the first surface having a maximum height (Sz) surface roughness of greater than 60 micrometers (μm), a maximum peak height (Sp) surface roughness of greater than 40 micrometers (μm), and an arithmetical mean height (Sa) surface roughness greater than 10 micrometers (μm).

2. The electrode of claim 1, wherein the surface roughness of the first surface is about 10 to 180 micrometers (μm).

3. The electrode of claim 1, wherein the at least one active material includes graphite.

4. The electrode of claim 1, wherein the electrode has a minimum specific capacity of charge of about 168 to 178 milliampere-hours per gram mass (mAh/g).

5. The electrode of claim 1, wherein the electrode has a minimum columbic efficiency of 99%.

6. The electrode of claim 1, wherein the coating includes a plurality of overlapping material pixels that define the more than one layer thereof.

7. The electrode of claim 1, wherein the coating includes edges that include protrusions extending from the first surface and a central region therebetween.

8. The electrode of claim 11, wherein the coating includes at least one protrusion extending from the first surface to an extent of at least 80 micrometers (μm) above portions of the first surface adjacent thereto, wherein the presence of the protrusion does not negatively affect the electrochemical performance of the electrode.

9. A battery comprising:
an electrode comprising:
a current collector; and
a coating on the current collector, the coating including more than one layer of at least one active material and having a first surface facing away from the current collector, the first surface having a maximum height (Sz) surface roughness of greater than 60 micrometers (μm), a maximum peak height (Sp) surface roughness of greater than 40 micrometers (μm), and an arithmetical mean height (Sa) surface roughness greater than 10 micrometers (Gm).

10. The battery of claim 9, wherein the surface roughness of the first surface of about 10 to 80 micrometers (μm).

11. The battery of claim 9, wherein the at least one active material includes graphite.

12. The battery of claim 9, wherein the electrode has a minimum specific capacity of charge of about 168 to 178 milliampere-hours per gram mass (mAh/g).

13. The battery of claim 9, wherein the electrode has a minimum columbic efficiency of 99%.

14. The battery of claim 9, wherein the coating includes a plurality of overlapping material pixels that define the more than one layer thereof.

15. The battery of claim 9, wherein the coating includes edges that include protrusions extending from the first surface and a central region therebetween.

16. The battery of claim 9, wherein the coating includes at least one protrusion extending from the first surface to an extent of at least 80 micrometers (μm) above portions of the first surface adjacent thereto, wherein the presence of the protrusion does not negatively affect the electrochemical performance of the battery.

17. A method comprising:
forming a donor layer of a donor material on a donor substrate;
locating the donor layer adjacent to and spaced apart from a receiving substrate;
generating a laser beam having a wavelength, wherein the donor substrate is substantially transparent at the wavelength of the laser beam;
directing, with a processor of a controller, the laser beam toward the donor substrate such that the laser beam passes through the donor substrate and is focused on an interface between the donor substrate and the donor layer;
controlling, by the processor, irradiation of the donor layer with the laser beam to cause portions of the donor layer to eject and contact the receiving substrate to form material pixels thereon;
forming a solid body comprising more than one layer of the material pixels; and
producing the electrode wherein the coating of the electrode includes at least a portion of the solid body and the current collector of the electrode includes at least a portion of the receiving substrate.

18. The method of claim 15, wherein the solid body is one of a plurality of spaced apart solid bodies on the receiving substrate.

19. The method of claim 15, further comprising segmenting the solid body into more than one portion, wherein the coating of the electrode includes one of the more than one portions of the solid body.

20. The method of claim 15, further comprising installing the electrode in the battery.
